(19) United States
(12) Patent Application Publication
(10) Pub. No.: US 2004/0049609 A1
(43) Pub. Date: Mar. 11, 2004

(54) Mechanism for integrating programmable devices into software based frameworks for distributed computing

(76) Inventors: Peter Simonson, Greenville, NH (US); Kazem Haji-Aghajani, Amherst, NH (US); Matthew J. Thiele, Hampstead, NH (US); Frank D. Stroili, Hollis, NH (US); Kevin P. Natwick, Hudson, NH (US); Robert P. Boland, Wilmington, MA (US)

Correspondence Address: MAINE & ASMUS, 100 MAIN STREET, P O BOX 3445, NASHUA, NH, 03061-3445, US

(21) Appl. No.: 10/650,172

(22) Filed: Aug. 28, 2003

Related U.S. Application Data
(63) Continuation-in-part of application No. 10/303,441, filed on Nov. 25, 2002.
(63) Continuation-in-part of application No. 10/233,338, filed on Aug. 30, 2002.
(60) Provisional application No. 60/407,554, filed on Aug. 29, 2002.

(51) Int. Cl. G06F 3/00

(52) U.S. Cl. 710/8

(57) ABSTRACT

A layered mechanism for integrating programmable devices into software based frameworks for distributed processing wherein the software framework interfaces with an adaptation layer, which in turn interfaces with a programmable device, such as a field programmable gate array (FPGA). The adaptation layer specifies and enforces compatible electrical, physical and logical interfaces between the programmable device and the software-based framework of which the device, the application running on it, and the adaptation layer form a component

### RELATED APPLICATIONS

This application claims the benefit of U.S. Provisional Application No. 60/407,554, filed Aug. 29, 2002. In addition, this application is a continuation in part of U.S. application Ser. No. 10/303,441, filed Nov. 25, 2002 and U.S. application Ser. No. 10/233,338, filed Aug. 30, 2002. Each of these applications is herein incorporated in its entirety by reference.

### FIELD OF THE INVENTION

This present invention relates to distributed computing and more particularly, to interfaces between software-based frameworks for distributed computing and programmable devices.

### BACKGROUND OF THE INVENTION

The rapid evolution of technology has posed significant problems, as well as benefits. Some technologies never achieve their full potential while others evolve rapidly, leaving earlier versions obsolete shortly after they have been installed. Technologies may need to be frequently substituted or otherwise adapted to compensate for different needs. Software can be a means of allowing integration of new hardware or allowing existing hardware to fulfill new functions.

Large-scale software development has evolved rapidly from its inception. Through the 1980s large-scale software was developed in modular systems of subsystems. Even today these are the most common systems in use. These systems are largely hardware dependent, problems or errors could be detected down to the level of the subsystem. These systems were based on point solutions where the problem/solution is functionally decomposed into subsystems. Potential reuse of the software for other applications must be anticipated during development and integrated into the software design. Extensions of the software are difficult and can only be achieved when such extensions were anticipated and designed into the system architecture itself.

In the 1990s, some improvement came with the advent of Object Oriented Systems (OOS). These software systems encapsulate data and operations into software objects. The objects have publicly defined interfaces (operations or methods), and internal or private computations and data or state storage. Object Oriented Systems were still deficient in a number of respects. OOS are still hardware dependent, they are designed for specific hardware configurations and modules are not productized. These systems were based, like their predecessors, on point solutions. The point solutions for OOS are derived using Object Oriented Analysis. Extension of the system using existing components was difficult as a result of the multiplicity of languages used.

In recent years, research and development has centered on layered or component based systems. In such a system a thin common layer or component base class is used in the development of all software modules. Each of the major capabilities of the system is represented by at least one module or component. These modules or components are thus “wrapped” in the thin common layer. Independent components are developed, tested, and packaged independently of each other, and while operating have no knowledge of their environment, since all input/output is constrained to interface ports connected from the outside. Run time discoverable parameters control specific behavior.

Component technology has in recent years become an area of increasing interest given the above challenges. Component technologies such as CORBA, common object request broker architecture, allow for increased flexibility when implementing business processes. By combining components many different software products can be created from existing modules. This increases the speed and efficiency of software development thereby better meeting client and internal demands and costs associated with development.

Software components allow reuse by performing a particular function and providing an appropriate interface with a larger system. Each component is ideally autonomous regarding its particular functionality. This autonomy allows changes to be made with individual components without disturbing the configuration of the entire system.

A system of reusable and flexible components is especially useful for military contractors. In the past, software was designed specifically for a contract. When a new contract was bid for, the contractor started from scratch. As discussed above, differences in language and architecture prevented different functionalities from being reused from earlier contracts. Since the software was newly developed there remained a relatively high risk of failure in the software or its interfaces, therefore the new software required testing and packaging, adding to the cost of the contract. The application of a flexible framework of reusable and interchangeable components would enable a client to leverage earlier development investments and minimize risk of failure in the development process. Contractors would be able to provide clients with more accurate and lower bids and possibly prototypes or catalogues of products easily configured to the clients needs.

Customarily, large computations of partitionable problems with time constraints are performed using distributed processing. Distributed processing systems of general purpose or special purpose computers, use a framework of common electrical, physical, and logical interfaces to specify and enforce compatible interfaces between software programs executing on those computers that perform discrete defined processing (components). The software system of components and framework is implemented on the network of distributed processors, where one or more software components execute on a processor. When the computation problem is such that using a distributed processing system of general purpose or special purpose computers requires more processing time and resources than can be provided in the processors, an alternative approach is used. To obtain more processing per volume or per cost, the accepted methods use specialized digital hardware such as FPGAs, gate arrays, or special purpose integrated circuits, connected using specialized interfaces.

These specialized interfaces may have commonality in terms of physical and electrical interface, but have not been common in terms of logical interface, nor have had the complexity required of modern software based interfaces. These mechanisms do not provide a common, controllable interface such that these specialized digital hardware such as FPGAs, gate arrays, or special purpose integrated circuits can interface in a common way to the other software-based signal and data processing components in the distributed system. Furthermore, these specialized interfaces do not support various modes of reusability. It is the attribute of reusability that enables cost-effective system development and rapid time to market.

There is at present, no satisfactory commercial or published standard or mechanism to simplify the use of embedded FPGAs, Gate Arrays and or special purpose integrated circuits in the distributed processing systems of general purpose or special purpose computers such that these devices interface in a common way to the other software-based signal and data processing components in the distributed system.

The evident reduction in engineering effort and minimization of difficulties associated with the specification, harmonization and enforcement of compatible interfaces between software programs executing in a network of general-purpose computers using the component—framework approach suggested the possibility that a similar approach might be taken with computing nodes containing FPGAs, gate arrays, and or special purpose integrated circuits.

Clearly what is needed is a mechanism for integrating these programmable devices into software based frameworks for distributed computing that renders the interface to these programmable devices the same or compatible with interfaces to software components.

### BRIEF SUMMARY OF THE INVENTION

An object of the invention is to provide a compatible mechanism for integrating programmable devices in software based frameworks for distributed computing.

One embodiment of the present invention provides a system for the implementation of integrating physical devices into a software based framework for distributed processing, that system comprising: at least one physical device; an adaptation layer, comprising an adaptation layer interface and the at least one device object, the device object comprising at least one capability object and one physical device interface object; the physical device interface object corresponding to and controlling electrical interfaces to the physical device; at least one software component interface communicating with the adaptation layer interface; at least one software component, coupled to the software component interface. The adaptation layer controls the physical device through the software component interface.

According to another embodiment, the physical device is at least one physical device chosen from the group of physical devices consisting of programmable devices, general purpose processors, specialized circuits, and field programmable gate arrays.

According to embodiments of the present invention, at least one software component interface may be common to software-based frameworks for distributed computing and may comprises at least six service interfaces.

A further embodiment of the present invention provides least one software component interface comprising a communication service interface and a control service interface.

Another embodiment of the present invention provides such a system with the at least one software component interface comprising a deployment service interface, a communication service interface, a communication connection service interface, an engineering service interface, a control service interface, and a component behavior control interface.

A still further embodiment of the present invention provides an adaptation layer interface, the adaptation layer interface providing a single point of interface between the adaptation layer and the at least one software component interface.

Still another embodiment of the present invention provides a physical device interfaced to a general purpose processor. A processor core may be deployed on at least one physical device. The physical device interface object of such a system may control physical device independently from a functionality performed by the physical device

One embodiment of the present invention provides a capability object controlling a functionality performed by the physical device independently from the physical device. Such a physical device, physical device interface object, and capability object may each, according to various embodiments be replaceable.

Yet another embodiment provides a system where the capability object provides activities for compliance with a software framework for distributed processing: deployment, control, behavior control, establishment of connections for communications, communication and data transfer, and data sampling and output.

In such a system, the capability object may comprise: at least one base instance object, at least one communication object, having a communication instance object, and at least one engineering object, having an engineering instance object.

A yet further embodiment of the present invention provides such a system wherein the base instance object, the communication instance object, and the engineering instance object are replaceable.

An even further embodiment of the present invention provides a system for the control of a software component operating on a software based framework, that system comprising: a capability object deployed on a device object corresponding to a physical device, the capability object comprising at least one base instance object, at least one communication object, and at least one engineering object.

Another embodiment of the present invention provides a physical device that is at least one physical device chosen from the group of physical devices consisting of programmable devices, general purpose processors, specialized circuits, and field programmable gate arrays.

A further embodiment of the present invention provides a base instance that is configured to provide deployment, control, and behavior control activities. In such a system, the communications object may be configured to provide establishment of connections for communications and communication and transfer of data activities. Such a system may also include an engineering object configured to sample data at a test point and transfer to an application for display and analysis. The communication object may comprise a communication instance object, the communication instance object may be configured to provide deployment, control, and behavior control activities.

A still further embodiment of the present invention provides an engineering object that comprises an engineering instance object, the engineering instance object is configured to provide deployment, control, and behavior control activities. Such a system may also provide both communication instance object and an engineering instance object; the communication instance object, the engineering instance object, and the base instance object each being independently replaceable.

One embodiment of the present invention provides a system for distributed processing, that system comprising: a distributed processing framework, a plurality of processors interfaced with the framework, a client application software communicating with the framework, at least one of software component deployed on the plurality of processors, each processor executing the software components, each software component controlling a programmable device via an adaptation layer, the adaptation layer comprising an adaptation layer interface, at least one device object, at least one capability object deployed on the device object, that device object having a physical device interface object; and the capability object and the physical device interface being independently replaceable. In such a system, the processor may be chosen from the group of processors comprising programmable devices, general purpose processors, specialized circuits, and field programmable gate arrays. In such a system the software components may be deployed on each processor.

A further embodiment of the present invention provides a method for implementing a software component on a software based distributed computing framework, the method comprising: deploying a program on at least one physical device by obtaining a current status of at least one physical device and loading the program on at least one available physical device; initiating processing of the program; controlling the program by discovering parameters, setting the parameters, and resetting the parameters; communicating data to and from the program; terminating the processing of the program; and resetting the physical device after the processing of the program. Such a method may also include the further step of performing at least one functionality with the program. The step of initiating the processing of the program may comprise gaining access to a capability, and setting the state of one or more bits in a control register in a physical device.

A further embodiment of the present invention provides a step of terminating the processing of the program which comprises gaining access to a capability object, and setting the state of one or more bits in a control register in a physical device.

Another embodiment of the present invention provides a step of resetting the programmable device which comprises: initializing a physical device; mapping memory; setting initial attributes of associated objects; destroying capability objects; removing structures from memory; and de-allocating memory and objects.

A still further embodiment of the present invention provides the step of controlling the program comprises the sub-steps of: creating a map of physical memory addresses of physical device registers to names of parameters for each instance within each capability of each the device; gaining access to at least one capability; obtaining a set of descriptions of the parameters available to the capability within the physical device; returning a set of name and value pairs available for the capability; and writing the parameters.

Yet another embodiment of the present invention provides a method comprising: receiving a request to establish an engineering test point monitor; gaining access to a communications object; setting memory addresses for the data; attaching to selected interrupt service routines, interfaces, and drivers; notifying the software components of the data transmission; enabling the collection of test point data within the programmable device; and transferring data to a processor.

A still further embodiment of the present invention provides such a method comprising: replacing a first physical device with a second physical device; and substituting a first physical device interface object, configured to interface with the first physical device, with a second physical device interface object, configured to interface with the second physical device.

Another embodiment of the present invention provides such a method comprising: replacing a first program with a second program on the physical device; and substituting a first capability object whereby the first program is controlled with a second capability object configured to control the second program. Such a system may alternatively comprise: replacing a first program with a second program on the physical device; and substituting a first at least one instance object whereby at least one aspect of the first program is controlled with a second at least one instance object configured to control at least one aspect of the second program.

A still further embodiment of the present invention may provide such a method of adding at least one additional capability object to an adaptation layer having a first capability object controlling at least one program; deploying a plurality of programs on the physical device. Alternatively such a method may provide adding at least one additional physical device; and adding at least one additional physical device object to an adaptation layer, the physical device object corresponding to at least one additional physical device, the adaptation layer having at least one physical device object whereby an existing physical device is controlled. Alternatively one may replace the program and the physical device.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of the interaction between special purpose processor using FPGA(s), gate array(s), or special purpose circuit(s), an adaptation layer providing a standardized interface, the standardized interface to a framework for distributed computing, and a general-purpose processor executing software component(s), compliant with the framework interface, in the distributed computing system according to one embodiment of the present invention.

FIG. 2A is a block diagram illustrating the typical layered interface of software components, as defined and required by the framework, in a distributed processing system configured according to one embodiment of the present invention.

FIG. 2B is a block diagram of a single software component, illustrating the various services that are constituent to the interfaces of a software component in a distributed processing system configured according to one embodiment of the present invention.

FIG. 3 is a block diagram of a single software component that uses programmable devices, illustrating the connections between the interfaces, the adaptation layer, and the physical programmable device, configured according to one embodiment of the present invention.

FIG. 4 is a class diagram illustrating the interrelationships between the objects that compose the adaptation layer configured according to one embodiment of the present invention.

FIG. 5 is a class diagram illustrating the classes and the methods of the components that compose the adaptation layer configured according to one embodiment of the present invention.

FIG. 6 is a block diagram illustrating a distributed processing system having a plurality of functions, implemented on general purpose processors and specific purpose processors having programmable devices and an adaptation layer.

FIG. 7 is a block diagram illustrating how a software radio may be implemented on a distributed processing system implemented on general purpose processors and specific purpose processors having programmable devices and an adaptation layer.

### DETAILED DESCRIPTION OF THE INVENTION

One embodiment of the present invention is layered mechanism for integrating programmable devices into software based frameworks for distributed processing wherein the software framework interfaces with an adaptation layer, which in turn interfaces with a programmable physical device, such as a field programmable gate array (FPGA). The adaptation layer specifies and enforces compatible electrical, physical and logical interfaces between the programmable device and the software-based framework of which the device, the application running on it, and the adaptation layer are a component. Each component meets the required interfaces from the framework interfaces and complies with the required behavior of a component.

In one embodiment, a specialized processing element (implemented as FPGAs, gate array, specialized integrated circuit, or parts of FPGAs, referred to in the remainder of this document as FPGA or programmable device) performs computation on input data and produces computation output. The specialized processing element has simple interfaces for control of the processing by the processing element. The specialized processing element generally has a device specific mechanism for downloading the programmable content, initialization, and control of processing.

An adaptation layer is implemented in a processor core on the FPGA, on a separate FPGA mounted on the board, or in a general purpose or special purpose processor that is electrically interfaced to the FPGA. The adaptation layer provides translation of the physical, electrical, and logical interfaces of the FPGA to the physical, electrical, and logical interfaces required of a software component executing in a distributed processing system. The adaptation layer interfaces to similar/complementary interfaces of other software components executing in a distributed processing system.

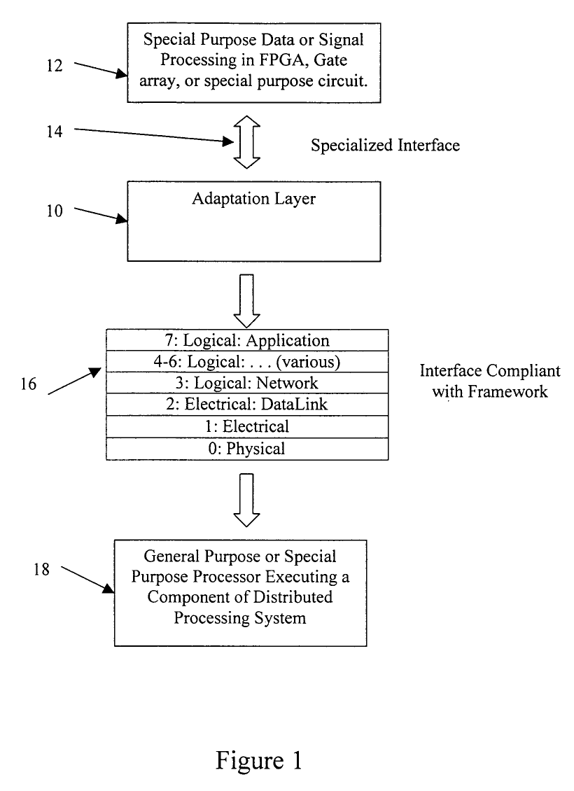

FIG. 1 illustrates one embodiment of the present invention with an adaptation layer 10, a specialized processing element 12, and interfaces 14, 16. In FIG. 1, the special purpose data or signal processing 12 implemented on at least one FPGA, gate array, or special purpose circuit is an implementation typically selected to reduce power or physical volume to perform the required computations. The specialized interface 14 is generally used by the special purpose data or signal processing device 12, typically optimized for throughput performance and simplicity. The adaptation layer 10 when used in combination with the special purpose data or signal processing 12 and specialized interface 14 permits the power/volume optimized implementation of the required signal or data processing to be used in a distributed processing system interfacing, via a complex framework compliant interface 16 with other processing components 18. Adaptation layer 10 matches the specialized interface 14 to the complex interface compliant with the framework 16 used by each processing element.

One embodiment of this invention is through the use of a processor core in the FPGA, executing a software program providing the adaptation layer 10 or through the use of a general purpose processor 18 executing a software program providing the adaptation layer 10, on a module containing the required physical and electrical interfaces, and the capability to provide the required logical interfaces, to which is interfaced the FPGA 12.

Historically, the two approaches of a software based distributed system with complex interfaces, and the specialized circuit based distributed system with simple interfaces, have come from opposite approaches to the system design solution. The invention described herein combines the heritage “software” approach with its more complex and flexible interfaces with the heritage “hardware” approach with its higher performance for a given power/volume/unit cost footprint.

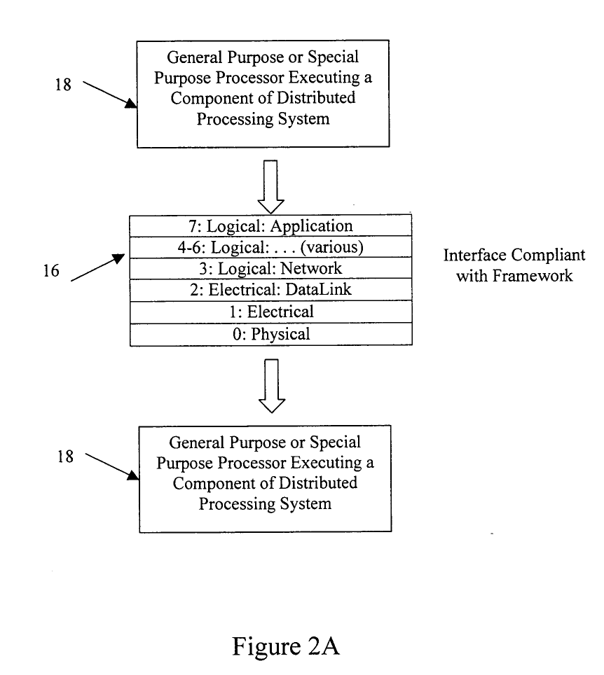

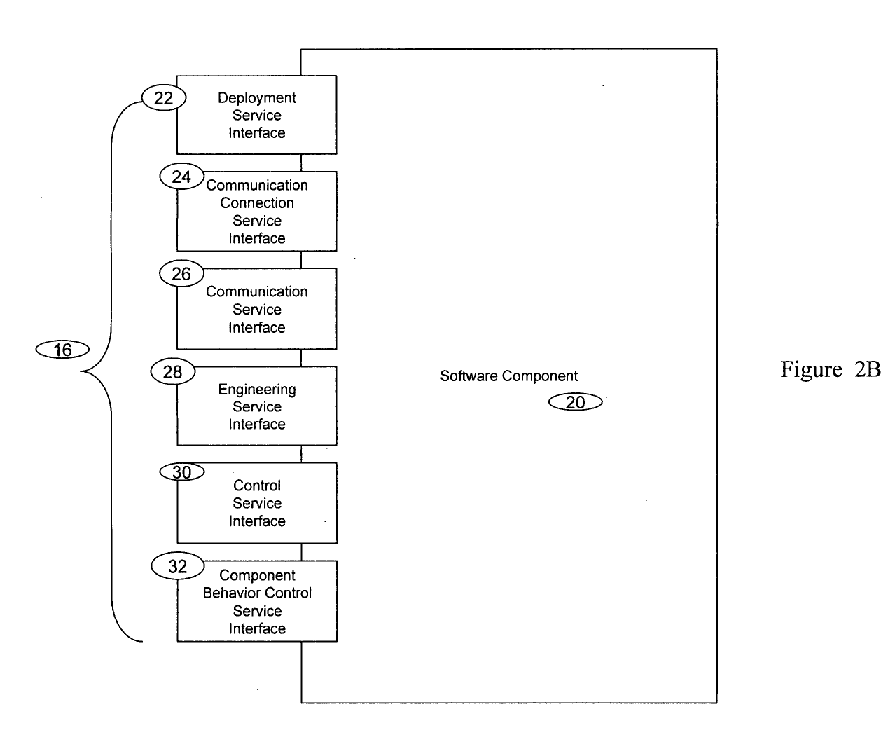

In FIG. 2A, the typical interfaces of software components in a distributed processing architecture are illustrated, showing the general purpose processors 18 executing software components of a distributed processing system, connected by an interface compliant with the framework 16, shown as a schematic of the typical complex interface between these components.

In FIG. 2B, some of the services in a complex interface 16 for software components 20 of a distributed processing architecture are shown. In general, frameworks for distributed processing by software on general or special purpose processors have all or many of these services. FIG. 2B illustrates interfaces 16 between a software component and distributed processing, software based framework. These interfaces, according to one embodiment of the present invention, include a deployment service interface 22, a communication connection service interface 24, a communication service interface 26, an engineering service interface 28, a control service interface 30, and a component behavior control service interface 32. These include interface mechanisms to: support the ability to load and execute the executable image (software object code file(s) or FPGA configuration file(s)) on any processor(s) in the system having sufficient quantity and type of execution resources to execute the image; support the ability to establish at run-time (during the execution of the distributed program) connection-based communications between software components deployed on any processor in the system; support the communication of signal, data, and other information from any software component to any other software component deployed on any processor in the system; interface mechanisms to support runtime discovery of, and obtaining data from engineering test points to sample selected data being processed by the component for the purpose of being plotted (represented graphically) on a remote computer; support run-time discovery of, and obtaining data from monitoring points to sample accumulated statistics on the processing within a component for the purpose of being displayed or analyzed on a remote computer; support run-time discovery of, and change of, parameters of the component that change the behavior of the component and/or its processing; and support the start, stop and resetting of processing within a component, and the shutdown and/or unloading of executable images from the processor executing the component.

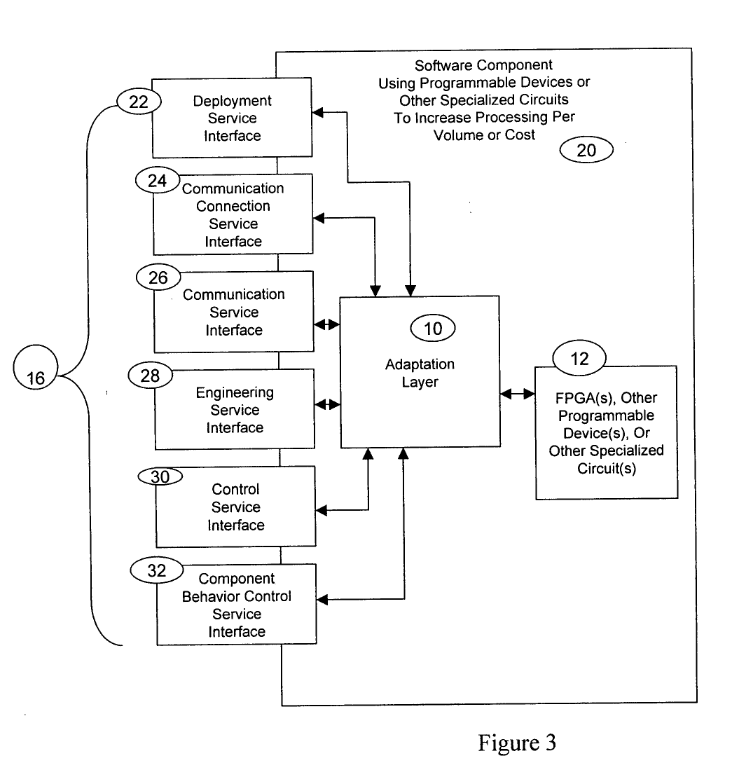

In FIG. 3, the same services in a complex interface 16 for software components that use programmable devices, FPGAs, or specialized circuits to increase processing per cost or volume 20 of a distributed processing architecture are shown.

In general, the simple, specialized interfaces 14, illustrated in FIG. 1 do not provide these services. The adaptation layer 10, illustrated in FIG. 1 provides these services, permitting the higher performance (in terms of power, volume, and possibly unit cost) FPGA implementation to interact in the system as if it were a component implemented in software, adhering to all the complex interface specifications.

FIG. 3 illustrates one embodiment of the present invention providing a single software component 20 of a typical component-framework software architecture for distributed processing that uses an FPGA, programmable device, or other specialized circuit 12 to accelerate processing in the component, beyond what could be accomplished in a general purpose computer. This is another view of the illustration in FIG. 1. The adaptation layer 10 provides the translation of the required component interfaces and behavior to the interfaces of the FPGA 12.

FIG. 3, illustrates, for one embodiment of the present invention, the interfaces the component 20 uses to interact with various services provided by a framework. These interfaces include the interface to the deployment service 22, which provides the ability to load and execute the executable image such as a software object code and/or FPGA configuration file. The communication connection service interface 24, which provides the ability to establish communications between components 20 at run time. The communication service interface 26, which provides for the communication or interchange of signal, data, and other information from one software component to another deployed on the system; the engineering service interface 28, which permits the sampling of data internal to the component for the purpose of rendering a graph on some graphical user interface as part of system integration and debugging activities. The component behavior control service interface 32 which provides for the starting, stopping, shutting down, and resetting of processing within the component; and the control service interface 30 which provides for the control of component behavior at run time through the discovery and changing of parameters that affect the component processing.

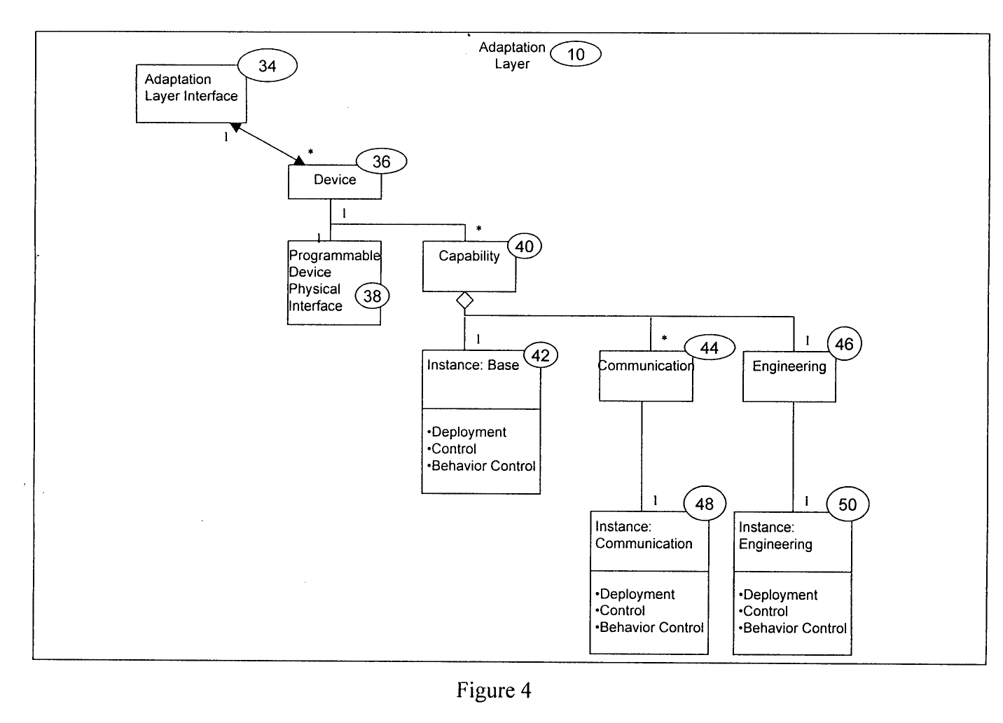

FIG. 4 details the Adaptation Layer 10 configured according to one embodiment of the present invention. The Adaptation Layer 10 has an adaptation layer interface 34 that is the single interface point for each set of FPGAs, programmable devices, or specialized circuits that are associated together, such as by being co-located on the same circuit board or as a bus slave to a single processor. According to alternative embodiments of the present invention, multiple adaptation layer interfaces 34 may be provided. The adaptation layer interface 34 is essentially a container object for device objects 36 which are the software abstraction of each physical FPGA, programmable devices, or specialized circuits that are associated together. Each device object 36 contains the interface methods and attributes for each physical programmable or specialized device.

Each device object 36 has an associated programmable device physical interface object 38 that is the software abstraction for interfacing to the programmable device or FPGA 12, for those interfaces that are independent of the programmed load of the device.

Each device object 36 has at least one capability object 40. Each capability object is the software counterpart to the part of the program within the programmable device that performs the algorithm or other processing. There is a one-to-one correspondence between the capability object 40 and the part of the program within the programmable device that performs the processing for some function. That is, for each part of the programmable device that performs the processing for some function, installed (loaded) onto the device at loading time, there is also a capability object created in the adaptation layer program at loading time. This capability object 40 is created when the programmable device is commanded to be loaded with at least one function implemented by the programmable device. Each capability object 40 is composed of a base instance object 42 that provides the deployment, control, and behavior control of the actual part of the programmable device performing the function associated with the capability object 40. All instance objects have a common control interface, and specialized interfaces and behavior for the particular function or capability implemented in the programmable device being controlled they are objects of class instance. The capability object 40 is also composed of some number of communication objects 44, and at least one engineering object 46.

The communication object 44 has an associated communication instance object 48 to provide the deployment, control, and behavior control of the actual part of the FPGA or programmable device that effects the communication or transfer of data between capabilities on the programmable device, from one programmable device to another, and/or to and from the programmable device and the general purpose processor. According to one embodiment, the communication object 44 has essentially the same interfaces and instance object 48 as the capability object itself 40 and the base instance object 42.

The engineering object 46 has an associated engineering instance object 50 to provide the deployment, control, and behavior control of the actual part of the FPGA or programmable device that provides for the sampling and the communication or transfer of this sampled data between the capability on the programmable device and the general purpose processor, for the purpose of rendering a graph on some graphical user interface as part of system integration and debugging activities. The engineering object 46 has essentially the same interfaces and instance object 50 as the capability itself 40 and the base instance 42. The Engineering object 46 is specialized to sample and transfer the sampled data between the capability on the programmable device and the general purpose processor, for the purpose of rendering a graph on some graphical user interface as part of system integration and debugging activities. The Communications object 44 is specialized to effect the communication or transfer of data between capabilities on the programmable device, from one programmable device to another, and/or to and from the programmable device and the general purpose processor. Each have an associated object of class instance providing common interfaces, but the instance objects themselves are unique for the corresponding part of the FPGA or programmable device they control.

The Programmable Device Physical Interface object 38 has a common control interface but is specialized or extended for each particular physical programmable device 12 and its interconnection and interface mechanism to the general purpose processor 18. For example if the physical device is a brand X4000, the Programmable Device Physical Interface object 38 has a common control software interface, yet has a specific physical device interface, unique to the X4000. If the X4000 device were replaced with the A200 in another implementation of this invention, the Programmable Device Physical Interface object 38 would be replaced with another object having the same control software interface, but a specialized physical device interface unique to the A200.

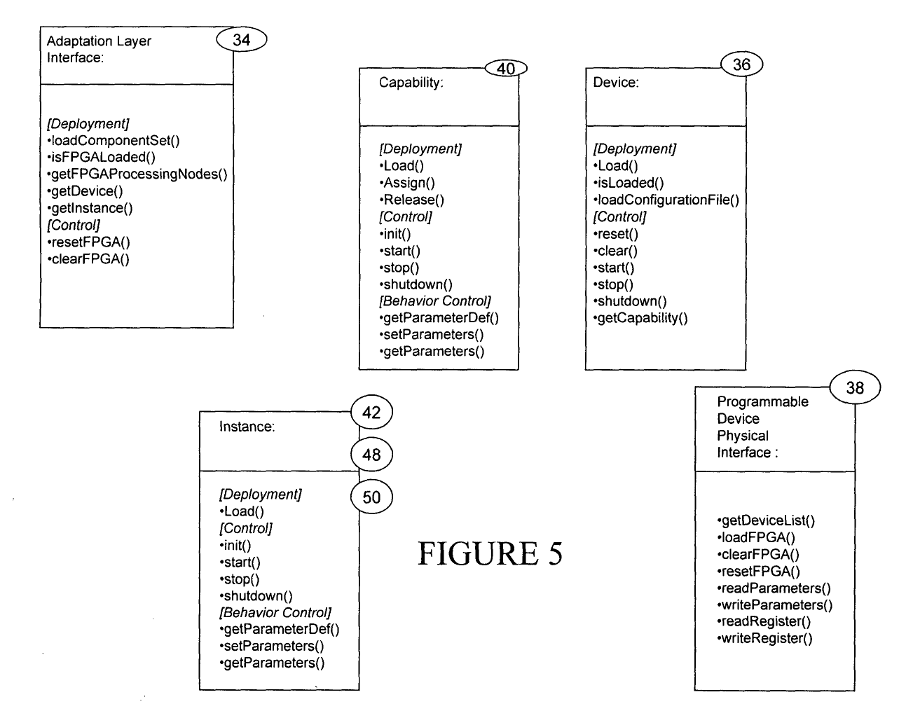

FIG. 5 contains details on methods, from one embodiment of the present invention, of the some of the objects depicted in FIG. 4. In particular the methods or invocation interfaces for the Adaptation Layer interface 34, the methods for the Capability 40, the methods for the device 36, the methods for a instance 42, 48, 50, and the methods for the Programmable Device Physical Interface 36 are shown. In various alternative embodiments, additional methods may be added, methods combined, or alternative interfaces implemented that perform the same function. Those skilled in the art will readily appreciate that alternative embodiments would be within the scope of the present invention that may include other methods or functionalities.

According to one embodiment of the present invention, the adaptation layer 10, by both its definition and mechanism, enables the use of the software component interface 16 to control programmable devices 12 in a system that uses a software based framework for distributed processing, such that the programmable devices are controlled as and behave as software components 20—a single system interface regardless of implementation.

The system identifies the six service interfaces 16, of components 20 common to software-based frameworks for distributed processing. One of ordinary skill in the art will readily appreciate that alternative embodiments having any number of interfaces would be within the scope of the present invention.

According to one embodiment of the present invention, the adaptation layer interface 34 is the single point of interface for the adaptation layer 10 and the six framework service interfaces 16.

One embodiment of the present invention uses device objects 36 in the adaptation layer 10, associated with the adaptation layer interface 34, such that there is one device object for each physical programmable device, FPGA, or special purpose circuit 12. In one embodiment the programmable device is electrically and mechanically interfaced to a general purpose processor, and in another a processor core is programmed into one or more of the programmable devices.

The device object 36 is associated with a programmable device physical interface object 38, and one or more capability objects 40, thereby providing separation of functionality into two categories. The first category is the control and management of the physical programmable device performed by the programmable device physical interface object 38, which is independent of the actual algorithm or functional capability performed by such a physical device. The second category is the control and management of the algorithm or functional capability provided by the programmable device by the capability object 40, which is independent of the actual physical programmable device.

This separation of physical device and algorithm or functional capability is a feature that enables the physical device to be replaced, upgraded, or optimized independent of its capability, hence preserving the investment made in the development of the capability object software, and the software for the software component, and the other software in the distributed processing system. Likewise, separation of physical device and algorithm or functional capability is a feature that enables the algorithm or functional capability programmed into the physical programmable device to be replaced, reconfigured, or modified, while using the same physical device, hence preserving the investment made in the procurement or fabrication of the programmable device, its physical interfaces to its associated processor, the general purpose processor board or equipment, and the other electrical and mechanical equipment in the distributed processing system.

The capability object 40, according to one embodiment of the present invention, is comprised such that it provides the six activities for compliance with a software framework for distributed processing: deployment, control, and behavior control, establishment of connections for communications, the actual communications transfer of data, and the sampling of data at a test point and its transfer to an outside application for display and analysis.

In one embodiment, the capability object 40 has a base instance object 42, a communication object 44, and an engineering object 46. The base instance object 42 provides three of the activities for compliance with a software framework for distributed processing: deployment, control, and behavior control. The communication object 44 provides two of the activities for compliance with a software framework for distributed processing: establishment of connections for communications, and the actual communications transfer of data. The engineering object 46 provides one activity for compliance with a software framework for distributed processing: the sampling of data at a test point and its transfer to an outside application for display and analysis.

The instance objects 42 are specialized for communications or engineering with the communications object(s) 44 and engineering object 46, such use of inheritance of the interface resulting in only three activities being required rather than six. Such reduction results in the simplification and reduction of software required to implement this invention.

In one embodiment, the communication object 44 has associated with it an instance object specialized or extended for communications 48. This communications instance object 48 has the same interface methods and fundamental behavior as the base instance object, but the exact operation of these interface methods is specialized for communications. In object-oriented terms the communications instance object 48 inherits its interfaces from the class of the base instance object 42.

In one embodiment, the engineering object 46 has associated with it an instance object specialized or extended for engineering 50. This communications instance object 50 has the same interface methods and fundamental behavior as the base instance object 42, but the exact operation of these interface methods is specialized for engineering. In object-oriented terms the engineering instance object 50 inherits its interfaces from the class of the base instance object 42.

The sequence and flow of interactions of the invention, the interfaces and adaptation layer 10, will be described in context of the operation of the interface with the framework 16, and each of the service interfaces of the software component. According to one embodiment, and to simplify the following description, the framework interfaces 16 of the component 20 may be considered as server, or passive, interfaces, where a client, or active, computer program requests service from these server interfaces, with the exception of the interaction where the component communicates data to another component or application outside the framework. For this description, neither the identity or nature of the particular client, nor the precise interface mechanism of the framework is relevant. The sequences and flows will be described starting at the point inside each particular service interface of the framework interface 16. As a note of terminology, the “invocation of a method” or similar expression generally refers to a software program performing a function call or returnable branch to a subroutine to the step in the program that implements a public operation on an object. Those skilled in the art will readily appreciate that alternate or additional sequences using the parts of the invention may also exist, and these would be within the scope of the present invention.

Deployment. The adaptation layer 10 provides deployment services by one of two means.

Deployment is the loading of the program (executable image) for processors an/or programmable devices.

One embodiment is to have the adaptation layer 10 implemented on a general purpose 18 or special purpose processor 12 electrically adjacent to the FPGA(s), the load of executable image containing the executable image for both the program(s) for the general purpose 18 or special purpose processor 12, and the set of all possible executable images for the FPGA. The executable image of the FPGA may be incorporated by reference (e.g. by referring to the file name(s) of the FPGA executable images) rather than actual inclusion.

The second embodiment is to have the FPGA load a boot image, a minimum core of processor functionality, including the adaptation layer 10, which meets the interface required of software components in a framework for distributed architecture software. In either embodiment, after a processor reset or power on, the executable software image for the component including the adaptation layer 10 is loaded and execution of the program(s) started.

Sequence of deployment. The deployment service interface 22 of the component, or a similar deployment service interface of the framework of the component-framework architecture, invokes the getFPGAProcessingNodes( ) method of the Adaptation layer interface 34 to obtain the list of available device objects which corresponds to the physical programmable devices that are associated together, such as by being co-located and electrically and logically interconnected and on the same circuit board or as a bus slave to a single processor. For example, if there are three programmable devices co-located on the same processor and interfacing to the processor, there will be three device objects 36. These device objects are typically defined at compile time. The deployment service interface 22 then invokes loadComponentSet( ) method on the adaptation layer interface 34 to load the desired devices with the desired program. Alternatively, the deployment service interface 22 may first invoke the isFPGALoaded( ) method to ascertain if loading or reloading is necessary, or if the programmable device is already loaded with the desired program. The adaptation layer interface 34 iterates through each specified device object 36. For each specified device object the adaptation layer invokes the isLoaded( ) method and if required, creates the capability objects 40 and the objects that compose the capability 42, 44, 46, 48, 50; invokes the loadConfigurationFile( ) to obtain descriptions of the capability objects and the programmable device implementation of that functionality as is described below as part of the control services interface mechanism; and invokes the Load( ) method to instantiate the functionality on the programmable device by loading the bitstream file. In programmable devices where partial loading of the device program is not possible or undesirable due to resulting inefficiencies largely due to the state of the art in programmable devices, the device object 36 invokes the loadFPGA( ) method on the Programmable Device Physical Interface object 38. For programmable devices where partial loading of the program is possible and is desired, the device object 36 invokes the Load( ) method on the Capability object 40 that invokes the Load( ) methods on the instance objects composing the Capability object 42, 48, 50. Each of the Load( ) methods of the instances 42, 48, 50 in turn invoke the loadFPGA( ) method of the associated Programmable Device Physical Interface object 38 which is specialized for the particular programmable device being partially loaded. The Load( ) methods of the instance objects 42, 48, 50 load only the programmable device program parts associated with the instance objects 42, 48, 50, and the LoadFPG( ) method of the associated Programmable Device Physical Interface object 38 is responsible for the unique loading mechanism of the particular programmable device. As is seen above, the Adaptation Layer 10 implements the mechanism of complying with the required interface and behavior for the deployment service interface 22 of a software component 20 that uses programmable devices in a software component-framework architecture. Some example capability objects, and the corresponding algorithm implementation in the programmable device, include Fast Fourier Transform, digital filter, encryption, etc.

Component behavior control. Component behavior control is the support of the start, stop and resetting of processing within a component, and the shutdown and/or unloading of executable images from the processor executing the component.

The adaptation layer 10, according to one embodiment, supports the component behavior control service interface 32 by accepting the commands for start and stop of execution and using these to enable or inhibit notification of the FPGA 12 that new data has arrived via communication services more fully described below and/or to enable or inhibit notification of the adaptation layer 10 that new data arrived from the FPGA 12 via communication services. The adaptation layer 10 supports the resetting of processing by activating any reset capability within the FPGA 12 and its programmed capability that does not cause erasure, deletion, or invalidation of its stored configuration file. The adaptation layer 10 supports the shutdown or unloading of processing by activating any reset capability within the FPGA 12 and its programmed capability that does cause erasure, deletion, and/or invalidation of its stored configuration file, and then activating a small software program segment that erases the remainder of the component software program executing in the processor.

Sequence of component behavior control for starting processing. The component behavior control service interface 32 of the software component 20 gains access to the individual capability 40 within a device 36 contained in the Adaptation Layer Interface 34, by using the getInstance( ) method of the Adaptation Layer Interface 34. Note that this describes one possible embodiment. Other embodiments could have specialized methods of the Adaptation Layer Interface 34 that provide direct access to the instance objects 42, 48, 50. In any case the component behavior control service interface 32 of the software component 20 invokes the start( ) method on the Base instance object 42 of the capability 40. The start( ) method on the instance 40 sets the state of one or more bits in a control register in the FPGA, by invoking the writeRegister( ) method of the associated Programmable Device Physical Interface object 38. The control of the internal operation of the FPGA or programmable device is via registers, which are may be directly memory mapped to the memory space of the general purpose processor, or in alternative embodiments, via some similar scheme where the registers are mapped to a secondary bus address, where the address is set by writing to a memory mapped or input/output register mapped address register, an alternative embodiment. In general, an FPGA 12 or programmable device implementation has a register control to start and stop processing. In an alternative embodiment, the control of the capability implemented in the FPGA 12 is controlled by enabling or disabling the communication of data to and or from the FPGA 12, using this same mechanism.

Sequence of component behavior control for stopping or resetting processing. In a similar manner the stop and reset commands accepted at the component behavior control service interface 32 of the component 20 cause the stop( ) method or init( ) method of the instance object 42 to be invoked and likewise bit(s) in a register in the FPGA 12 is set or reset as required to stop processing by the FPGA 12 or to reset internal registers of the FPGA 12 to a known state, without causing erasure, deletion, or invalidation of its stored configuration file. In general programmable device or specialized hardware implementations of processing have these interface functionalities, although the precise implementation is unique to the programmable device program.

Sequence of component behavior control for shutting down of processing. The shutdown behavior is accomplished by one embodiment of the present invention, by the component behavior control service interface 32 of the software component 20 invoking the resetFPGA( ) method on the Adaptation Layer Interface 34 of the Adaptation layer 10. This method causes the invocation of the clearFPGA( ) method on the Programmable Device Physical Interface 38. The clearFPGA( ) method causes a programmable device specific reset, clearing device. This reset is specific to the programmable device and the electrical design of the circuits interfacing the general purpose processor. In general, this is effected by setting or clearing some bits in some registers that are directly memory mapped to the memory space of the general purpose processor or via some similar scheme where the registers are mapped to a secondary bus address, where the address is set by writing to a memory mapped or input/output register mapped address register, an alternative embodiment. Additionally, the Adaptation Layer 10 appropriately sets the internal attributes of its associated objects and destroys the capability objects 40, removes structures from memory and de-allocates memory, and any objects that compose the capability objects 42, 44, 46, 48, and 50.

As is seen above, the Adaptation Layer 10 implements the mechanism of complying with the required interface and behavior for the component behavior control service interface 32 of a software component that uses programmable devices 12 in a software component-framework architecture.

Control. Control is run-time discovery of, and change of, parameters of the component that change the behavior of the component and/or its processing. The adaptation layer 10 supports the control services interface by providing programmed self-description of the available parameters that control the behavior of the embedded FPGA and its processing. This self-description means an outside application can obtain descriptions of the parameters at run-time. Furthermore, the adaptation layer 10 provides communication of the parameters, as set by a remote computer, from the general purpose processor 12 memory space, used by whatever software communications mechanism is required by the framework, to the input memory space or registers of the FPGA used to control the FPGA behavior.

To change the operation of a capability within the programmable device 12 as if it were a software component 20, a remote computer or another program on the same computer uses the control service interface 30 to discover the definition of the parameters, to get the current parameter values, and to change any of the parameter values. The details of the operation of the invention to perform these operations are described in more detail herein.

Sequence of initialization of control by parameters. During the deployment operations described above, after the capability objects 40 are created, the loadConfigurationFile( ) method is invoked on the device object 36. The loadConfigurationFile( ) method, when invoked, creates a map of physical memory addresses of the programmable device registers to names of parameters for each device for each capability, for each instance within. The control of the internal operation of the programmable device is via registers, which may be directly memory mapped to the memory space of the general purpose processor or via some similar scheme where the registers are mapped to a secondary bus address, where the address is set by writing to a memory mapped or input/output register mapped address register, an alternative embodiment. The mapping of parameter name to memory address is obtained from a file located on the processor file system, where the file name and path is passed to the device object at as an argument of the loadConfigurationFile( ) method. This file contains directly or by inclusion, the pair of parameter name, i.e. a string or set of alphanumeric characters, and address, i.e. a number, for each register that controls the behavior of each function or capability in the programmable device. Each parameter name—address pair may be augmented by descriptions of the parameter, including minimum and maximum permissible values, or enumerated values, and a default value. In one embodiment this mapping is distributed to the instance objects that compose each capability that compose the device, although in other embodiments, the mapping may be centralized in the device object.

Sequence of control by discovering parameter definitions. In one embodiment, upon communication of the request to obtain the parameter definitions of the component 20, from a remote computer, or another program on the same computer, the control service interface 26 of the software component 20 gains access to the individual capability 40 within a device 36 contained in the Adaptation Layer Interface 34, by using the getInstance( ) method of the Adaptation Layer Interface 34. Other embodiments could have specialized methods of the Adaptation Layer Interface 34 that provide direct access to the instance objects 42, 48, 50. In any case the control service interface 30 of the software component 20 invokes the getParameterDef( ) method on the Base instance 42 of the capability object 40. This method returns a set of descriptions of the parameters available for that particular capability within the programmable device corresponding to the capability object 40. The descriptions contain the parameter name, minimum and/or maximum values, and/or permitted values, and the default value. These descriptions were those loaded during an earlier loadConfigurationFile( ) method invoked on the device object 36 containing the capability object 40. These descriptions are returned through the adaptation layer interface 34 to the control service interface 30.

Sequence of control by discovering parameter values. Upon communication of the request to obtain the current parameter values of the component 20, from a remote computer, or another program on the same computer using the mechanism described in the preceding paragraph for getting parameter descriptions, the control service interface 30 of the software component 20 invokes the getParameters( ) method on the Base instance 42 of the capability object 40. This method returns a set of name and value pairs of the parameters available for that particular capability within the programmable device corresponding to the capability object 40. If the particular implemented function in the programmable device is controlled by a readable register, this is implemented by the base instance object 42 repeatedly invoking the readParameters( ) method on the Programmable Device Physical Interface 38 for each of the parameter names defined in the parameter-address map created during an earlier loadConfigurationFile( ) method invoked on the device object 36 containing the capability object 40. The readParameters( ) method simply reads the value in a register of the programmable device at the address, for the name supplied. The control of the behavior of the functions implemented in the programmable device is controlled by values in a register. If the particular implemented function in the programmable device is controlled by a write-only register, then the current value of the register is kept as an attribute of the instance object, and is returned. These parameter values are returned through the adaptation layer interface 34 to the control service interface 30.

Sequence of control by changing parameter values. Upon communication of the request to set or change the current parameter values of the component 20, from a remote computer, or another program on the same computer using the mechanism described in the preceding paragraphs for getting parameter descriptions, the control service interface 30 of the software component 20 invokes the setParameters( ) method on the Base instance 42 of the capability object 40. This method is supplied as an argument a set of name and value pairs of the parameters to be changed for that particular capability within the programmable device corresponding to the capability object 40. This is implemented by the instance 42 repeatedly invoking the writeParameters( ) method on the Programmable Device Physical Interface for each of the parameter names defined in the parameter-address map created during an earlier loadConfigurationFile( ) method invoked on the device object 36 containing the capability object 40. The writeParameters( ) method simply writes the value in a register of the programmable device at the address, for the name supplied. As described above, the control of the behavior of the functions implemented in the programmable device are controlled by values in a register.

As is seen above, the Adaptation Layer 10 implements the mechanism of complying with the required interface and behavior for the control service interface 30 of a software component 20 that uses programmable devices 12 in a software component-framework architecture.

Communication. The adaptation layer 10 provides communication connection services by managing the mapping from the general purpose processor 10 memory space, used by whatever software communications mechanism(s) are required by the framework, to the input memory space or registers of the FPGA. This mapping includes the establishment of means of notification by various means that new data has arrived for processing by the FPGA. Likewise the adaptation layer manages the mapping of the output memory space or registers of the FPGA to the general purpose processor memory space, used by whatever software communications mechanism(s) are required by the framework. Again this mapping includes the establishment of means of notification that new data has been emitted by the FPGA 12 for communication to other components 20 on any of the various processors in the distributed processing system. The adaptation layer 10 provides communication services by actually moving data whether by a combination of processor instructions or by establishing and enabling DMA channels from the general purpose processor 18 memory space, used by whatever software communications mechanism(s) are required by the framework, to the input memory space or registers of the FPGA. This communication includes the notification by various means that new data has arrived for processing by the FPGA 12. Likewise the adaptation layer 10 provides communication services by actually moving data whether by a combination of processor instructions or by establishing and enabling DMA channels from the output memory space or registers of the FPGA 12 to the general purpose processor memory space, used by whatever software communications mechanism(s) are required by the framework. Again this communication includes the notification that new data has been emitted by the FPGA 12 for communication to other components on any of the various processors in the distributed processing system.

It may be seen that the communication and communication connection capability in the programmable device is another function within the programmable device, but having a special association with the function being controlled. This function within the programmable device that performs communications may contain simple data registers and handshake protocol registers, or may contain complex DMA engines for elaborate and efficient transfers of blocks of data to and from scattered memory locations in the general purpose processor and in the various registers in the programmable device. The communication function in the programmable device will be unique for the peculiar programmable device design, and peculiar electrical interface. The control of such a communication function is performed by an instance object specialized for communication and for the peculiar programmable device implementation. This communication object 44 has an associated instance object, the communication instance object 48. The communication instance object 48, like any instance object in the invention, has the methods described previously to perform deployment, behavior control, and control.

Sequence of establishing communications. When a request to establish a connection into the component is received by the Communication Connection Service Interface 24 of the software component 20, it gains access to the communication object within the individual capability 40 within a device 36 contained in the Adaptation Layer Interface 34, by using the getInstance( ) method of the Adaptation Layer Interface 34. Note that this describes one possible embodiment. Other embodiments could have specialized methods of the Adaptation Layer Interface 34 that provide direct access to the instance objects 42, 48, and 50. In any case the Communication Connection Service Interface 24 of the software component 20 invokes the setParameters( ) method of the communication instance object 48 associated with the communication object 44 to set the memory addresses for the data buffer to be used to transfer data into or out of the programmable device, to set block sizes, and other relevant control values that map the memory space of the general purpose processor to the input memory or registers of the programmable device. The operation of the setParameters( ) method and related methods of the instance objects was described above. The communication object 44 attaches to interrupt service routines or other drivers or interfaces peculiar to the software communications mechanism(s) required by the distributed processing software framework, such that the arrival of data from the distributed processing software framework via the communication service interface 24 will be recognized by the component 20, establishing the means of notification that new data has arrived to be processed by the programmable device. The communication object attaches to interrupt service routines or other drivers or interfaces peculiar to the programmable device and its electrical interfaces to the general purpose processor, such that the arrival of data from the programmable device will be recognized by the component 20, establishing the means of notification that new data has arrived having been by the programmable device.

Sequence of communications, receiving. When data has arrived at the component 20 via the communication service interface 26, the interrupt service routines or drivers or other interfaces attached during the communication connection activity cause the data to be transferred into the programmable device. These interrupt service routines or drivers or other interfaces invoke the start( ) method on the communication instance object, which, as described previously, has already set register values that cause the memory addresses, block sizes, and other relevant control values to be used to transfer the data from the framework communication buffer to the programmable device memory. The transfer of data is performed by the communication function in the programmable device, which is controlled by the communication instance object 48. The exact transfer mechanism is peculiar to the design of the communication function programmed into the programmable device. In one embodiment, such a control function is a DMA, direct memory access, engine that rapidly transfers the data, upon the register set by start( ) being set to begin the transfer.

Sequence of communications, sending. In a similar manner, when the programmable device 12 indicates that there is data ready to be transferred from the programmable device 12 to the general purpose processor 18, the interrupt service routines or other drivers or interfaces peculiar to the programmable device 12 and its electrical interfaces to the general purpose processor 18 established in the communication connection activities above, invoke a method on the communication instance object 48 to set register values that cause the memory addresses, block sizes, and other relevant control values to be used to transfer the data from the programmable device memory to the framework communication buffer. The transfer of data is performed by the communication function in the programmable device 12, which is controlled by the communication instance object 48. The exact transfer mechanism is peculiar to the design of the communication function programmed into the programmable device 12. In one embodiment, such a control function is a DMA engine that rapidly transfers the data. Once the data has been transferred into the memory of the general purpose processor, any additional required computations may be performed, and the communication instance 48 invokes the appropriate method(s) on the communication service interface 26 to send the data to another component in the framework.

As is seen above, the Adaptation Layer 10 implements the mechanism of complying with the required interface and behavior for the communication connection service interface 24 and communication service interface 26 of a software component that uses programmable devices 12 in a software component-framework architecture.

Engineering. The engineering functionality permits the sampling of data internal to the component for the purpose of rendering a graph on some graphical user interface as part of system integration and debugging activities. The adaptation layer 10 supports the engineering services interface by providing programmed self-description of the available engineering test point interfaces, and available accumulated statistics, and by providing communication of this intermediate processed data from inside the FPGA 12 to the general purpose processor 18 memory space, used by whatever software communications mechanism(s) are required by the framework, and by providing communication of that data to any remote computer that requests this data in accordance with the interface specification. If the FPGA design does not permit inspection of any intermediate data, then the engineering services interface 28 behavior is set by the adaptation layer 10 to indicate this is the case.

It may be seen that the engineering test point capability in the programmable device 12 is merely another function within the programmable device 12, but having a special association with the function being controlled. The function that performs engineering test point in the programmable device 12 is controlled by registers, and communicates the test point data in a manner similar to communication of other data from the programmable device 12 to the general purpose processor 18. The engineering test point function in the programmable device will be unique for the peculiar programmable device design, and peculiar electrical interface. The control of such an engineering test point function is performed by an instance object specialized for engineering test points and for the peculiar programmable device implementation. This engineering object 46 has an associated instance object, the engineering instance object 50. The engineering instance object 50, like any instance object in the invention, has the methods described previously to perform deployment, behavior control, and control.

Sequence of establishing engineering test point. According to one embodiment, when a request to establish an engineering test point monitor into the component is received by the Engineering Service Interface 28 of the software component 20, it gains access to the communication object 44 within the individual capability 40 within a device 36 contained in the Adaptation Layer Interface 34, by using the getInstance( ) method of the Adaptation Layer Interface 34. Other embodiments may have specialized methods of the Adaptation Layer Interface 34 that provide direct access to the instance objects 42, 48, and 50. The Engineering Service Interface 28 of the software component 20 invokes the setParameters( ) method of the engineering instance object 50 associated with the engineering object 46 to set the memory addresses for the data buffer to be used to transfer test point data out of the programmable device, to set block sizes, collection triggers, and other relevant control values that map the memory space of the general purpose processor to the input memory or registers of the programmable device. The operation of the setParameters( ) method and related methods of the instance objects was described above. The engineering object 50 attaches to interrupt service routines or other drivers or interfaces peculiar to the programmable device and its electrical interfaces to the general purpose processor, such that the arrival of engineering test point data from the programmable device 12 will be recognized by the component 20, establishing the means of notification that new data has arrived having been by the programmable device 12.

Sequence of collecting data from engineering test point. When a request to trigger or enable an engineering test point data collection arrives at the component 20 via the engineering service interface 28, the start( ) method on the engineering instance object 50 is invoked as described previously. The invocation of the start( ) method sets register values that cause the triggering or enabling of triggering of the collection of test point data within the programmable device. When the data has been collected within the programmable device 12 and the programmable device 12 indicates data is ready to be transferred to the general purpose processor, the interrupt service routines or other drivers or interfaces peculiar to the programmable device and its electrical interfaces to the general purpose processor 18 established in the communication connection activities above, invoke a method on the engineering instance object 50 to set register values that cause the memory addresses, block sizes, and other relevant control values to be used to transfer the data from the programmable device memory to the general purpose processor. The transfer of data is performed by the communication function in the programmable device, which is controlled by the engineering instance object 50. The exact transfer mechanism is peculiar to the design of the engineering function programmed into the programmable device 12. In one embodiment, such a control function is a DMA (direct memory access) engine that rapidly transfers the data. Once the data has been transferred into the memory of the general purpose processor 18, the engineering instance 50 invokes the appropriate method(s) on the engineering service interface 28 to send the data to engineering user interface applications attached to, or resident within the software framework.

As is seen above, the Adaptation Layer 10 implements the mechanism of complying with the required interface and behavior for the engineering service interface 28 of a software component that uses programmable devices 12 in a software component-framework architecture.

One embodiment of the present invention enables reuse, reducing system development cost and time to market. These opportunities for reuse are described. The opportunities provided by general software frameworks for distributed processing are not described, neither are the opportunities provided by the use of a framework for VHDL or other hardware design description representations, as they are not the subject of this application.

First, consider the case of the replacement of the specific FPGA or programmable device 12 within the software component 20 with one of another model or manufacturer or electrical and logical interface, or with a specialized circuit. In this case the internal functionality of the programmable device or specialized circuit is the same, in one embodiment enabled through the use of a framework for programmable devices. The invention provides a method of reuse by replacing the Programmable Device Physical Interface object 38, located within the adaptation layer 10. Note that the interface (the methods) of the Programmable Device Physical Interface object 38 remain the same, only the underlying software for that object changes to accommodate the new or programmable device 12. With only the change of the Programmable Device Physical Interface object 38 and the programmable device 12, the interfaces, control, and behavior of the software component 20 remain unchanged, and hence the system it may be part of remains unchanged. Stated another way, the design of a new software component 20 performing the same function but using this replacement programmable device, reuses all the existing elements of the software component 20 and the adaptation layer 10 except the Programmable Device Physical Interface object 38. It is readily apparent to those proficient in the art that an entire system design and the design of all its constituent parts may be reused, except the Programmable Device Physical Interface objects 38 for this case.

Second, consider the case of the replacement of functionality within the programmable device 12. In this case the physical device 12 is the same or compatible, such that the interface to the physical device is the same. The invention provides a method of reuse by replacing the capability object 40 within the adaptation layer 10. This new capability object 40 is specialized for the functionality within the programmable device. Note that the interface (the methods) of the capability object 40 remain the same, only the underlying software for that object changes to accommodate the new functionality within the programmable device 12. Generally, this new capability object 40 requires new objects that that compose it 42, 44, 46, 48, 50 replace the existing objects. Note that here again, the interface (methods) of these objects remain the same, only the underlying software for those objects change to accommodate the new functionality within the programmable device 12. With only the change of the functionality in the programmable device, and its corresponding capability object 40, and any objects that compose it 42, 44, 46, 48, 50, the interfaces to the component 20 remain unchanged. Stated another way, the design of a new software component 20 performing a different function using the same programmable device, but programmed with a new program for a different functionality, reuses all the existing elements of the software component 20 and the adaptation layer 10 except the capability object 40 and the base instance object 42, the communication object 44, the communication instance object 48, the engineering object 46, and the engineering instance object 50, and reuses all the interfaces even for those objects replaced.

Thirdly consider the case of replacement of one part of the functionality within the programmable device 12, where this part of the functionality is limited to the deployment, control, behavior control, communications or engineering functionality. In this case the physical device 12 is the same or compatible, such that the interface to the physical device is the same. An example of this case is a change in design of the functionality within the programmable device to replace a single register data communications interface to a DMA controlled FIFO interface, while maintaining the balance of the functionality. The invention provides a method of reuse by replacing the particular instance object 42, 48, 50 within the adaptation layer 10. In the example, the communications instance object 48 is replaced with a new communications instance object that controls the DMA control registers and the FIFO instead of the single data transfer register. With only the change of the particular instance object 42, 48, 50 and the change in the part of the functionality in the programmable device 12, the interfaces, control, and behavior of the software component 20 remain unchanged, and hence the system it may be part of remains unchanged. Stated another way, the design of a new software component 20 performing the same function but using this replacement part of the functionality of the programmable device, reuses all the existing elements of the software component 20 and the adaptation layer 10 except the particular instance object 42, 48, 50. It is readily apparent to those proficient in the art that an entire system design and the design of all its constituent parts may be reused, except the particular instance object(s) 42, 48, 50 for this case.

Fourthly consider the addition of separate and distinct functionality within the programmable device 12, such that this additional functionality is controlled separately from existing functionality that exists within the programmable device. In this case the physical device 12 is the same or compatible, such that the interface to the physical device is the same. An example of this case is the addition of a digital filter function to the programmable device containing a frequency translation function, such as might be found in a digital signal processing application. The invention provides a method of reuse by adding another capability object 40 to the existing capability object 40 associated with the device object 36 within the adaptation layer 10. This new capability object 40 is specialized for the additional functionality within the programmable device. Note that the interface (the methods) of the additional capability object 40 are the same as the first capability object, only the underlying software for that new capability object changes to accommodate the added functionality within the programmable device 12. Generally, this new capability object 40 requires new objects that that compose it be created 42, 44, 46, 48, 50. Note that here again, the interface (methods) of these objects remain the same, with the underlying software for those objects new to accommodate the additional functionality within the programmable device 12. In the example, a new capability object corresponding to the digital filter functionality is created, with new objects that control its deployment, control, behavior control, communications, and engineering. With only the addition of the functionality in the programmable device, and its corresponding new capability object 40, and any objects that compose it 42, 44, 46, 48, 50, the interfaces to the component 20 may remain unchanged. Stated another way, the design of a new software component 20 performing an additional function using the same programmable device, but programmed with a new program for both functionalities, reuses all the existing elements of the software component 20 and the adaptation layer 10 and adds a new capability object 40 with its the base instance object 42, the communication object 44, the communication instance object 48, the engineering object 46, and the engineering instance object 50, and reuses all the interfaces even for those objects added.

Fifthly, consider the addition of a second or additional programmable device to the processor such that it may provide additional functionality in the case where there are insufficient numbers of unused logic gates within the programmed devices (e.g. the first programmable device). In this case the physical device 12 may the same or different. An example of this case is the addition of a digital filter function in a second programmable device to an existing programmable device containing a frequency translation function, such as might be found in a digital signal processing application. The invention provides a method of reuse by adding another device object 36 to the existing device objects 36 within the adaptation layer 10. Note that the interface (the methods) and its software of the additional device object 36 are the same as the first device object. This new device object 36 will have a Programmable Device Physical Interface object 38 specialized for the particular model of the physical device. This new device object 36 will have a new capability object 40. This new capability object 40 is specialized for the additional functionality within the additional programmable device. Note that the interface (the methods) of the additional capability object 40 are the same as any capability object, only the underlying software for that new capability object changes to accommodate the added functionality within the added programmable device 12. Generally, this new capability object 40 requires new objects that that compose it be created 42, 44, 46, 48, 50. Note that here again, the interface (methods) of these objects remain the same, with the underlying software for those objects new to accommodate the additional functionality within the additional programmable device 12. In the example, a new device object corresponding to the new programmable device is created and a capability object corresponding to the digital filter functionality is created, with new objects that control its deployment, control, behavior control, communications, and engineering. With only the addition of the new programmable device and its functionality, its new device object 36, its corresponding new capability object 40, and any objects that compose it 42, 44, 46, 48, 50, the interfaces to the component 20 may remain unchanged. Stated another way, the design of a new software component 20 performing an additional function using an additional programmable device, programmed with a new program for the new functionality, reuses all the existing elements of the software component 20 and the adaptation layer 10 and adds a new device object, a new capability object 40 with its the base instance object 42, the communication object 44, the communication instance object 48, the engineering object 46, and the engineering instance object 50, and reuses all the interfaces even for those objects added.

Sixthly, consider the replacement of a software component 20 that performs all its processing in a general purpose processor 18 with a software component 20 that uses a programmable device or specialized circuit 12 to accelerate the processing, or to reduce processing size, weight, and power consumption. This invention provides a method of reuse by replacing the software component 20 that performs all its processing in a general purpose processor 18 with a software component 20 that uses a programmable device or specialized circuit 12. Note that the interface (the methods) 16 of the components 20 remains the same, only the underlying software for that component changes to accommodate the programmable device 12. The interfaces 16, control, and behavior of the software component 20 remain unchanged, and hence the system it may be part of remains unchanged. Stated another way, the design of a new software component 20 performing the same function but using this replacement programmable device, reuses all the existing interfaces 16 of the software component 20. One of ordinary in the art will readily appreciate that, while individual physical devices or programs may removed, added, altered, or replaced, the overall system architecture will be largely unaffected, as the programs and devices interface with the adaptation layer, rather than to the framework directly.

It is readily apparent to one of ordinary skill in the art that various other combinations and variations of the methods described above would be within the scope of the present invention.

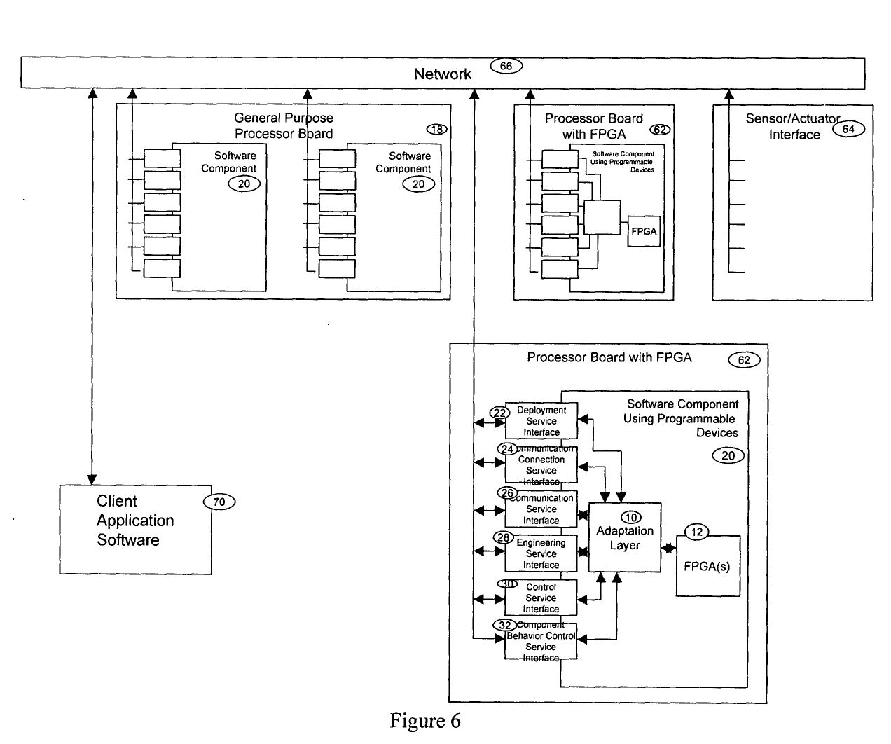

FIG. 6 illustrates the adaptation layer 10 as implemented in a particular embodiment of the invention, in the context of an overall software distributed processing system. Specific software components 20 that use processing algorithms or functions implemented on FPGA(s) or other programmable devices or specialized circuits 12 part of or mounted on (interfaced to) a processor board 62. The adaptation layer 10 interfaces the simple interfaces of the FPGA to the required framework service interfaces 22, 24, 26, 28, 30, 32 of the component 20. The component 20 interacts with other components that use programmable devices on other processor boards 62, via the network 66, using the framework interfaces on both components. The component 20 also interacts with other software components 20 that do not use programmable devices, but instead execute on general purpose processor boards 18. All these components 20, use the framework interfaces to interact with each other and with client application software 70 to perform the intended system purpose. This interaction is unchanged, in both form and behavior, whether the processing is implemented in the programmable device or the general purpose processor. The same mechanisms and interfaces are used to deploy, control behavior, control, communicate, or perform engineering of the components. The invention, a mechanism to integrate programmable devices into software based frameworks for distributed processing, thereby facilitates system development, and reconfiguration whether by the system developer or end user.

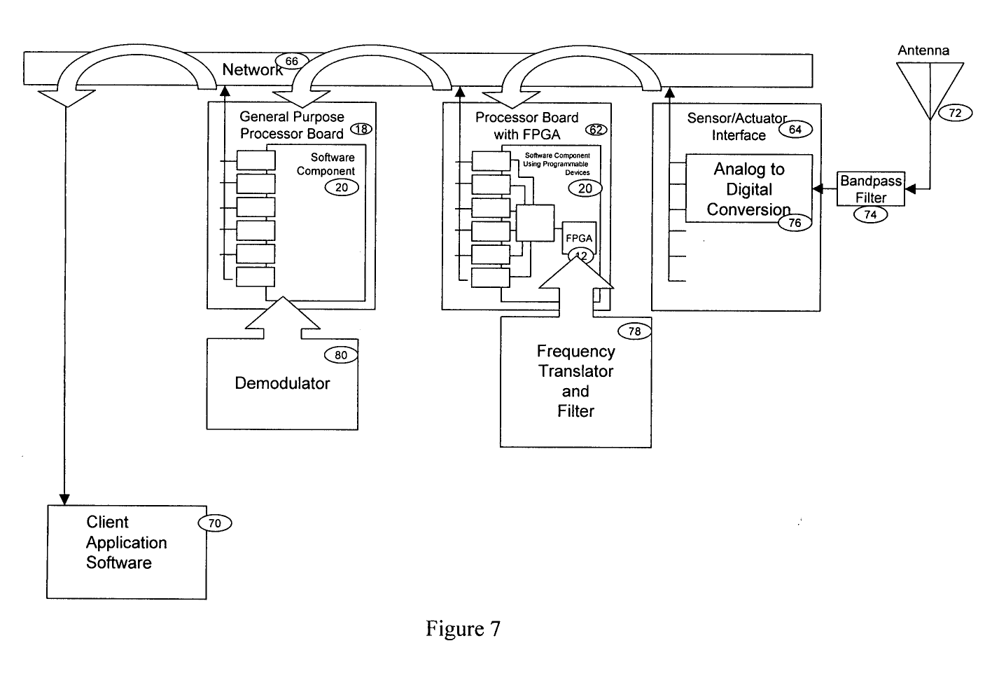

FIG. 7 is an illustration of an example of one embodiment of a system in which such an approach is used to implement distributed computing for a software radio receiver. The functions required for this software radio receiver example include a physical antenna 72 to convert the transmitted electromagnetic waves into an electrical signal, a bandpass filter 74 to select a portion of the frequency range of the electrical signal to be processed, an analog-to-digital conversion circuit 76 to convert the filtered electrical signal to a sequence of numbers representing the signal, a frequency translator and filter 78 to convert the represented signal from the carrier frequency to baseband, a demodulator 80 to extract intelligible data representing audio information from the baseband represented signal, and client application software 70 to play the data representing audio information out an audio speaker device (not shown). The analog-to-digital conversion circuit 76 is a particular example of a sensor/actuator interface 64 on the network 66. The frequency translator and filter 78 is implemented as a software component using a programmable device 20 where the signal processing is performed in a programmable device such as an FPGA 12, where the programmable device 12 resides on, and the software component 20 executes on, a processor board with a programmable device 62. This implementation is typical where the amount of processing per unit time required to perform this function exceeds the capacity of the general purpose processor board 18. The demodulator 80 is implemented as a software component 20 executing on a general purpose processor board 18. Both the processor board with a programmable device 62 and the general purpose processor board 18 are on the network 66, as is the client application software 70. The client application software 70 deploys, connects, and manages the components, and controls the behavior of the software component implementing the demodulator 20 and the software component implementing the frequency translator and filter 20. When the user, through the client application software, requests a change in processing, for example selecting a wideband code correlation receiver instead of a frequency translator and filter, the software for the component 20 can be unloaded, and a new component 20 that implements the required new functionality loaded onto the processor board with a programmable device 62, and connected to the analog-to-digital conversion circuit 76, and to the demodulator implemented as a component 20 on the general purpose processor board 18. In this way, the system may be continually redefined and reconfigured to enable the use of a wide variety of functions on a single system, the functions being defined by the software components selected, executed, and interconnected under the control of the client software 70. In this example, at the control of the client software, different radio configurations and processing may be created and destroyed, as the processing is performed by the software components. Through the use of the present invention, time critical or processing intensive segments of the processing may be cost effectively performed in programmable devices, yet controlled as a software component. The use of software to define the function provides greater flexibility to the user, and ultimately greater cost effectiveness. When the user's needs change, the configuration of the system can be readily altered, even when the processor is at a great physical distance from the user.

Other distributed computing applications so enabled by the use of this mechanism to integrate programmable devices into software based frameworks for distributed processing, that may take advantage of the run-time reconfiguration offered by such a software based framework include: signal processing systems on aircraft, ship, submarine, or motorized vehicle platforms where signals intelligence obtained from the current mission processing dictates a change in processing algorithm, or software, or even a change in system functionality such as from signals intelligence processing to moving target indicating RADAR processing, or acoustic processing; image processing systems for rendering computer-animated images where the image rendering process and software algorithm changes upon the input of the graphic artist; image processing systems for the analysis of images from real-world sensors (e.g. digital cameras), where the analyst operator needs to significantly change the algorithm processing as a result of image content observed; numerical analysis, simulation, and modeling systems for mechanical, nuclear, and electromagnetic applications, where complexity or volume of data requires the use of programmable devices in a distributed computing environment, and as the result of the simulation process, a different algorithm or simulation process is started; medical imagery processing where, after performing computed tomography and identifying a potential medical condition, the radiologist uses the same distributed computing plant and user interface to perform magnetic resonance imaging, using input from a different sensor, to confirm the diagnosis; large scale networked encryption and decryption processing for financial, military, and other sensitive transactions, where cryptographic algorithms need to be updated when the present algorithm is compromised or found to have a weakness.

Additional distributed computing applications so enabled by the use of this mechanism to integrate programmable devices into software based frameworks for distributed processing, that may or may not require run-time reprogrammability, but do require the use of programmable devices to minimize cost, weight, power, or volume include: miniature or airborne signal processing sensors for signals intelligence, RADAR, acoustic processing, radio reception radio transmission, and navigation; computer network switching for internetworking applications; terrestrial and satellite communications circuit switching, packet switching, and routing systems; cellular radio mobile telephone base stations where signal processing heretofore performed in analog radio-frequency equipment can be performed by digital programmable devices and integrated with the data processing required for call management and interface to the public telephone network; household appliance networks that integrate personal computers, audio and television equipment, fire and security sensors, dishwashers, ovens, washing machines, lighting, air conditioning, heating, and electrical power management processing.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for the implementation of integrating physical devices into a software based framework for distributed processing, said system comprising:
at least one physical device;
an adaptation layer, comprising an adaptation layer interface and said at least one device object, said device object comprising at least one capability object and one physical device interface object; said physical device interface object corresponding to and controlling electrical interfaces to said physical device;
at least one software component interface communicating with said adaptation layer interface;
at least one software component, coupled to said software component interface; and
wherein said adaptation layer controls said physical device through said software component interface.

2. The system according to claim 1 wherein said physical device is at least one physical device chosen from the group of physical devices consisting of programmable devices, general purpose processors, specialized circuits, and field programmable gate arrays.

3. The system according to claim 1 wherein said at least one software component interface is common to said software-based frameworks for distributed computing.

4. The system according to claim 1 wherein said at least one software component interface comprises at least six service interfaces.

5. The system according to claim 1 wherein said at least one software component interface comprises:
a communication service interface; and
a control service interface;

6. The system according to claim 1 wherein said at least one software component interface comprises:
a deployment service interface;
a communication service interface;
a communication connection service interface;
an engineering service interface;
a control service interface; and
a component behavior control interface.

7. The system according to claim 1 further comprising an adaptation layer interface, said adaptation layer interface providing a single point of interface between said adaptation layer and said at least one software component interface.

8. The system according to claim 1 wherein said at least one physical device is interfaced to a general purpose processor.

9. The system according to claim 1 further comprising a processor core deployed on at least one said physical device.

10. The system according to claim 1 wherein said physical device interface object controls said physical device independently from a functionality performed by said physical device

11. The system according to claim 1 wherein said capability object controls a functionality performed by said physical device independently from said physical device.

12. The system according to claim 1 wherein said physical device is replaceable.

13. The system according to claim 11 wherein said physical device interface object is replaceable.

14. The system according to claim 1 wherein said capability object is replaceable.

15. The system according to claim 1 wherein said capability object provides activities for compliance with a software network, said activities comprising:
deployment;
control;
behavior control;
establishment of connections for communications;
communication and data transfer; and
data sampling and output.

16. The system according to claim 1 wherein said capability object comprises:
at least one base instance object;
at least one communication object, having a communication instance object; and
at least one engineering object, having an engineering instance object.

17. The system according to claim 16 wherein said base instance object, said communication instance object, and said engineering instance object are replaceable.

18. A system for the control of a software component operating on a software based framework, said system comprising:
a capability object deployed on a device object corresponding to a physical device;
said capability object comprising:
at least one base instance object;
at least one communication object; and
at least one engineering object.

19. The system according to claim 18 wherein said physical device is at least one physical device chosen from the group of physical devices consisting of programmable devices, general purpose processors, specialized circuits, and field programmable gate arrays.

20. The system according to claim 18 wherein said base instance is configured to provide deployment, control, and behavior control activities.

21. The system according to claim 18 wherein said communications object is configured to provide establishment of connections for communications and communication and transfer of data activities.

22. The system according to claim 18 wherein said engineering object is configured to sample data at a test point and transfer to an application for display and analysis.

23. The system according to claim 18 wherein said communication object comprises a communication instance object, said communication instance object is configured to provide deployment, control, and behavior control activities.

24. The system according to claim 18 wherein said engineering object comprises an engineering instance object, said engineering instance object is configured to provide deployment, control, and behavior control activities.

25. The system according to claim 18 further comprising a communication instance object, a engineering instance object; said communication instance object, said engineering instance object, and said base instance object each being independently replaceable.

26. A system for distributed processing, said system comprising:
a distributed processing framework;
a plurality of processors interfaced with said framework;
a client application software communicating with said framework;
at least one of software component deployed on said plurality of processors;
each said processor executing said software components;
each said software component controlling a programmable device via an adaptation layer;
said adaptation layer comprising an adaptation layer interface, at least one device object, at least one capability object deployed on said device object, said device object having a physical device interface object; and
said capability object and said physical device interface being independently replaceable.

27. The system according to claim 26 wherein at least one said processor is a processor chosen from the group of processors comprising programmable devices, general purpose processors, specialized circuits, and field programmable gate arrays.

28. The system according to claim 26 wherein a plurality of said software components may be deployed on each said processor.

29. A method for implementing a software component on a software based distributed computing framework, said method comprising:
deploying a program on at least one physical device by obtaining a current status of at least one said physical device and loading said program on at least one available said programmable device;
initiating processing of said program;
controlling said program by discovering parameters, setting said parameters, and resetting said parameters;
communicating data to and from said program;
terminating said processing of said program; and
resetting said physical device after the processing of said program.

30. The method according to claim 29 further comprising the step of performing at least one functionality with said program.

31. The method according to claim 29 wherein said step of initiating the processing of said program comprises:
gaining access to a capability; and
setting the state of one or more bits in a control register in a physical device.

32. The method according to claim 29 wherein said step of terminating the processing of said program comprises;
gaining access to a capability object; and
setting the state of one or more bits in a control register in a physical device.

33. The method according to claim 29 wherein said step of resetting said programmable device comprises:
initializing a physical device;
mapping memory;
setting initial attributes of associated objects;
destroying capability objects;
removing structures from memory; and
de-allocating memory and objects.

34. The method according to claim 29 wherein the step of controlling said program comprises the sub-steps of:
creating a map of physical memory addresses of physical device registers to names of parameters for each instance within each capability of each said device;
gaining access to at least one said capability;
obtaining a set of descriptions of said parameters available to said capability within said physical device;
returning a set of name and value pairs available for said capability; and
writing said parameters.

35. The method according to claim 29 further comprising:
receiving a request to establish an engineering test point monitor;
gaining access to a communications object;
setting memory addresses for the data;
attaching to selected interrupt service routines, interfaces, and drivers;
notifying said software components of the data transmission;
enabling the collection of test point data within said programmable device; and
transferring data to a processor.

36. The method according to claim 29, further comprising:
replacing a first said physical device with a second physical device; and
substituting a first physical device interface object, configured to interface with said first physical device, with a second physical device interface object, configured to interface with said second physical device.

37. The method according to claim 29, further comprising:
replacing a first said program with a second said program on said physical device; and
substituting a first capability object whereby said first program is controlled with a second capability object configured to control said second program.

38. The method according to claim 29, further comprising:
replacing a first said program with a second said program on said physical device; and
substituting a first at least one instance object whereby at least one aspect of said first program is controlled with a second at least one instance object configured to control at least one aspect said second program.

39. The method according to claim 29, further comprising:
adding at least one additional capability object to an adaptation layer having a first capability object controlling at least one said program;
deploying a plurality of said programs on said physical device.

40. The method according to claim 29 further comprising:
adding at least one additional physical device; and
adding at least one additional physical device object to an adaptation layer, said physical device object corresponding to said at least one additional physical device, said adaptation layer having at least one said physical device object whereby an existing said physical device is controlled.

41. The method according claim 29 further comprising:
replacing said program and said physical device.
